(19) United States
(12) Patent Application Publication
(10) Pub. No.: US 2007/0106600 A1
(43) Pub. Date: May 10, 2007

(54) Real estate transaction method and system

(76) Inventor: Marinus Petrus Kouters, Oud-Gastel (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 11/270,041

(22) Filed: Nov. 9, 2005

(51) Int. Cl. G06Q 40/00

(52) U.S. Cl. 705/38

(57) ABSTRACT

A method to facilitate a real estate transaction of a property for sale from a seller. The method includes establishing sales information on at least an asking price for the property; establishing further information on the financial status of the property and seller; preparing mediation information for a third party for an intermediate finance of the property for a mediation price; and determining the mediation price in dependence on the asking price, wherein the mediation price is lower than the asking price.

### FIELD OF THE INVENTION

The present invention relates to a method to facilitate real estate transactions. Also, the present invention relates to a system to facilitate real estate transactions. Furthermore, the present invention relates to a computer program to facilitate real estate transactions, and to a data carrier comprising such a computer program.

### DESCRIPTION OF THE RELATED ART

International patent application WO 02/42871 describes a real estate transaction method and system, in which a broker allows a user to sell a first property and allows the user to purchase a second property via a computer communication network. In this method the broker accepts a first property sale offering from the user. Then, the broker provides a number of second property purchase offerings to the user and allows the user to accept a selection from these second property purchase offerings. Next, the broker transfers the sale proceeds from the sale transaction of the first property to the user, for use in purchasing the selected second property. Finally, he executes a purchase transaction of the selected second property, using the sale proceeds from the sale transaction of the first property as payment towards the purchase of the second property.

CA 2343702 discloses an independent mortgage solution which includes a method of managing a defaulting mortgage in which a third “independent” party is engaged to intervene inter alia between a mortgagee and a defaulting mortgagor, and between a property owner and a real estate agent.

Also, it is known that selling a house or property may take quite some time before the actual transaction to a new owner has been completed. The timing of a sale may be influenced by factors such as price and location, and many other circumstantial factors. Also, factors relating to basically supply and demand, may be involved.

It is further observed that many property owners who intend to sell, want to capitalize within the shortest time possible.

### SUMMARY OF THE INVENTION

It is an object of the present invention to provide a method to facilitate real estate transactions which can strongly reduce the time for a property owner to capitalize his property.

According to one aspect of the present invention, there is provided a method to facilitate a real estate transaction of a property for sale from a seller, the method comprising:
establishing sales information on at least an asking price for the property;
establishing further information on the financial status of the property and seller;
preparing mediation information for a third party for an intermediate finance of the property for a mediation price,
determining the mediation price in dependence on the asking price, wherein the mediation price is lower than the asking price.

According to another aspect of the present invention, there is provided a system to facilitate a real estate transaction of a property for sale from a seller, the system comprising a first database:
the first database comprising:
   sales information on at least an asking price for the property;
   further information on the financial status of the property and seller;
   mediation information for a third party for an intermediate finance of the property for a mediation price,
   the mediation price being determined in dependence on the asking price, wherein the mediation price is lower than the asking price.

According to yet another aspect of the present invention, there is provided an intermediate information server to facilitate a real estate transaction of a property for sale from a seller, comprising a processing unit, memory and a network I/O device for a connection to a network, the memory being connected to the processing unit, and the network I/O device being connected to the processing unit, wherein the intermediate information server is arranged for
establishing sales information on at least an asking price for the property;
establishing further information on the financial status of the property and seller;
preparing mediation information for a third party for an intermediate finance of the property for a mediation price,
determining the mediation price in dependence on the asking price, wherein the mediation price is lower than the asking price.

According to yet another aspect of the present invention, there is provided a computer system to facilitate a real estate transaction of a property for sale from a seller, and comprising a processing unit and memory, the memory being connected to the processing unit, the computer system being arranged for
establishing sales information on at least an asking price for the property;
establishing further information on the financial status of the property and seller;
preparing mediation information for a third party for an intermediate finance of the property for a mediation price,
determining the mediation price in dependence on the asking price, wherein the mediation price is lower than the asking price.

According to still another aspect of the present invention, there is provided a computer program to facilitate a real estate transaction of a property for sale from a seller, to be loaded by an intermediate information server, the intermediate information server comprising a processing unit, memory and a network I/O device for a connection to a network, the memory being connected to the processing unit, and the network I/O device being connected to the processing unit, the computer program product after being loaded allows the processing unit to carry out:
establishing sales information on at least an asking price for the property;
establishing further information on the financial status of the property and seller;
preparing mediation information for a third party for an intermediate finance of the property for a mediation price,
determining the mediation price in dependence on the asking price, wherein the mediation price is lower than the asking price.

According to yet a further aspect of the present invention, there is provided a computer program to facilitate a real estate transaction of a property for sale from a seller, to be loaded by a computer system, the computer system comprising a processing unit and memory, the processing unit being connected to the memory, the computer program product after being loaded allows the processing unit to carry out:
establishing sales information on at least an asking price for the property;
establishing further information on the financial status of the property and seller;
preparing mediation information for a third party for an intermediate finance of the property for a mediation price,
determining the mediation price in dependence on the asking price, wherein the mediation price is lower than the asking price.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts schematically a computer to use in an embodiment of the present invention;

FIG. 2 depicts schematically an arrangement of computer systems in accordance with an embodiment of the present invention;

FIG. 3 depicts a first flow diagram of a method in accordance with an embodiment of the present invention,

FIG. 4 depicts a second flow diagram of a method in accordance with an embodiment of the present invention, and

FIG. 5 depicts a third flow diagram of a method in accordance with an embodiment of the present invention.

### DETAILED DESCRIPTION

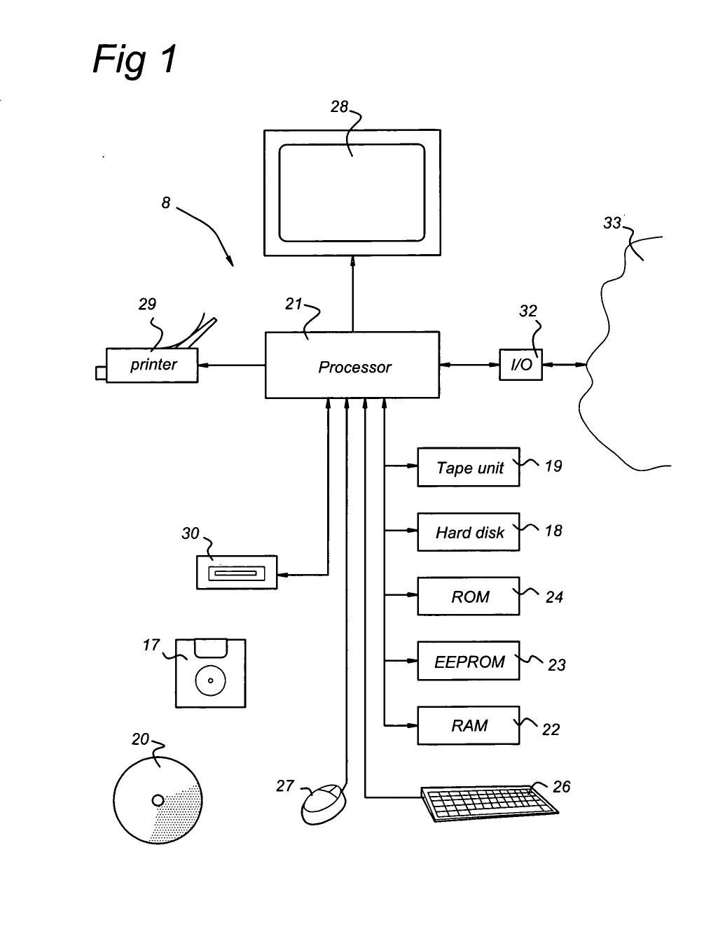

For the purpose of teaching of the invention, preferred embodiments of the method and devices of the invention are described below. It will be appreciated by the person skilled in the art that other alternative and equivalent embodiments of the invention can be conceived and reduced to practice without departing form the true spirit of the invention, the scope of the invention being limited only by the appended claims. FIG. 1 shows schematically a computer as used in an embodiment of the present invention. Computer 8 comprises host processor 21 with peripherals. The host processor 21 is connected to memory units 18, 19, 22, 23, 24 which store instructions and data, one or more reading units 30 (to read, e.g., floppy disks 17, CD ROM's 20, DVD's, a keyboard 26 and a mouse 27 as input devices, and as output devices, a monitor 28 and a printer 29. Other input devices, like a trackball, a touch screen or a scanner, as well as other output devices may be provided.

Further, a network I/O device 32 is provided for a connection to a network 33. The connection of the network I/O device 32 may be arranged for either a wired or wireless connection to the network 33.

The memory units shown comprise RAM 22, (E)EPROM 23, ROM 24, tape unit 19, and hard disk 18. However, it should be understood that there may be provided more and/or other memory units known to persons skilled in the art. Moreover, one or more of them may be physically located in an either adjacent or remote manner from the processor 21, if required.

The processor 21 is shown as one box, however, it may comprise several processing units functioning in parallel or controlled by one main processor, that may be located, adjacent or remote, from one another, as is known to persons skilled in the art.

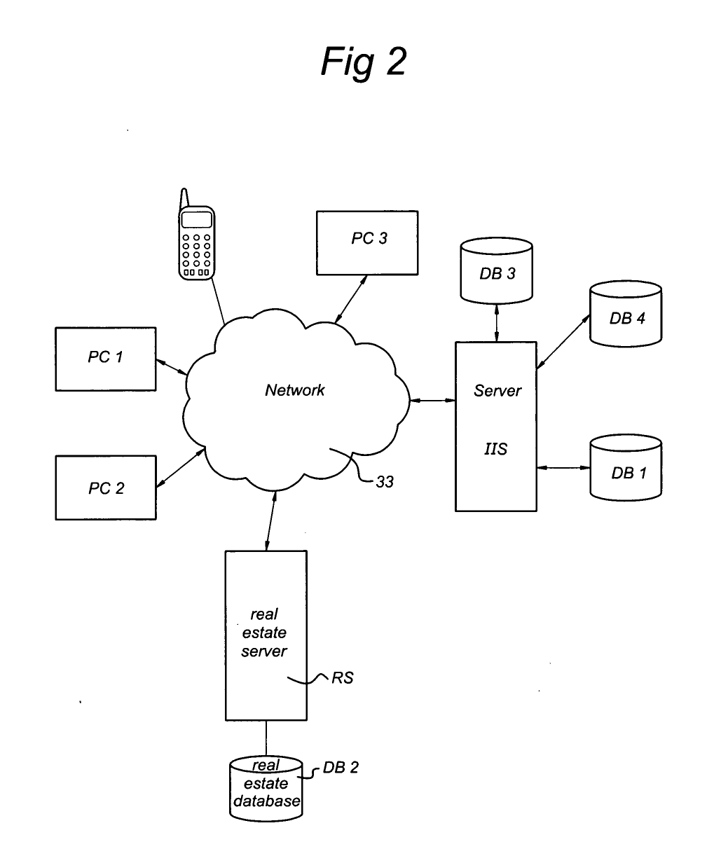

FIG. 2 depicts schematically an arrangement of computer systems in accordance with an embodiment of the present invention.

In FIG. 2 a network for data communication is shown, which comprises a plurality of computer systems pc1, pc2, pc3, a computer system IIS which acts as intermediate information server system, and at least one computer system RS which acts as an information server for real estate (real estate information server). All computer systems pc1, pc2, pc3, IIS and RS are connected to the network 33 through their respective network i/o device. Each computer system pc1, pc2, pc3, IIS, RS may be embodied as described with reference to FIG. 1.

The network for data-communication 33 may be any network suitable for data transmission and may comprise a plurality of interconnected networks, for example, Public Switched Telephone Networks (PSTN). For instance such an interconnected network may be a Local Area Network (LAN), or a Wide Area Network (WAN). Also, the network 33 may have the functionality of a world-wide data-communication network, known as the Internet.

Each computer system pc1, pc2, pc3, IIS, RS is arranged to communicate on the network 33 with one or more of the other computer systems pc1, pc2, pc3, IIS, RS or with one or more other communication devices such as personal digital assistant devices (not shown), suitable cellular phones (not shown), smartphones (not shown), etc. that have the capability to communicate over the network 33 using the functionality of, for example, Internet services such as world-wide-web browsing.

Intermediate information server computer system IIS comprises in memory a first database DB1 for storing and retrieving intermediate information as will be explained below.

Real estate information server computer system RS comprises in memory a second database DB2 for storing and retrieving real estate information as will be explained below.

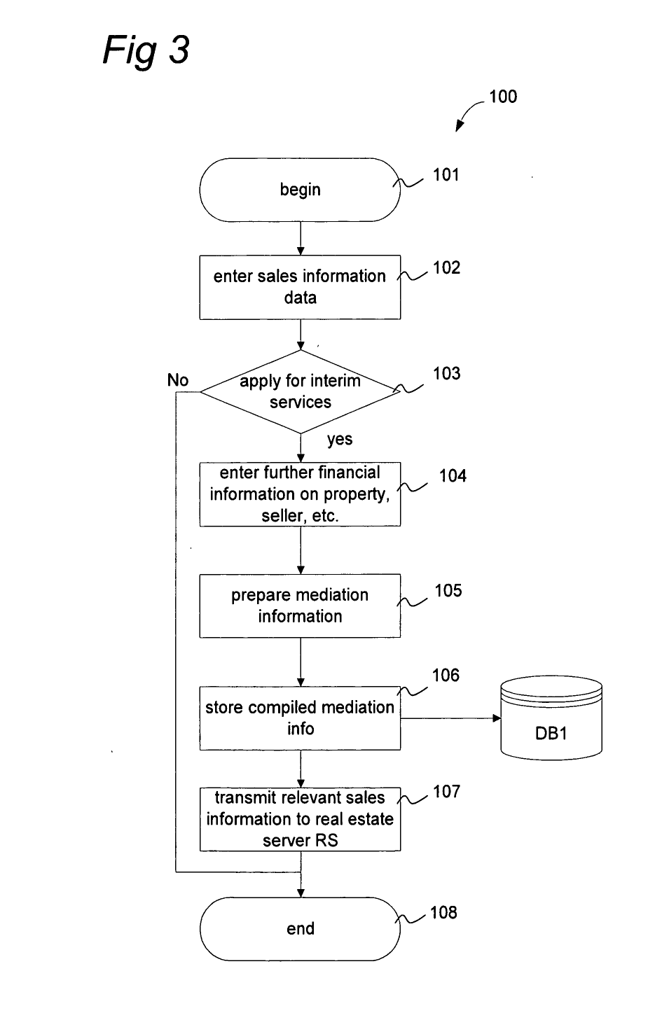

FIG. 3 depicts a first flow diagram of a method in accordance with an embodiment of the present invention.

A property owner intends to sell his house and contacts a real estate agent. The property owner (or seller) typically discusses his plan to sell his house with the real estate agent. During this discussion some sales information is recorded. Typically, an asking price which is assumably rational in view of the quality of the house, its location, etc, is established.

The method according to the embodiment is carried out as shown in procedure 100. Procedure 100 can be carried out by the intermediate information server IIS. An input device, for example, computer pc1 is used to communicate with the intermediate information server IIS.

In action 101, the procedure begins. Possibly some initializations are performed by the intermediate information server IIS.

In action 102, the sales information data relating to the house are entered into the memory of the intermediate information server IIS. Such sales information data are information about the asking price and for example, a description of the house (for example, number of rooms, occupied area, date of building, one or more photographs of the house), its location and the area of its terrain.

In action 103, the intermediate information server IIS provides an option to apply for so-called interim services. If a negative choice is made (option: no), the procedure continues in action 107, else it continues in action 104.

In action 107, the intermediate information server IIS transmits the sales information data relating to the house to the real estate information server RS. The real estate information server RS provides information on real estate for sale which as such is typically provided by real estate agents or an association of real estate agents. It is known that such real estate information servers provide information on property for sale, wherein the information can relate to the location, price, type of property, etc.

The intermediate information server IIS may be allowed to directly enter the sales information data relating to the house in the second database DB2 for storing and retrieving real estate information. Alternatively, the real estate information server RS may upon receipt of the sales information data, recompile the sales information data relating to the house into suitable sales information data to be stored in the second database DB2.

The abovementioned interim services relate to a mediation procedure which allows a seller to capitalize its property within a relatively shorter period than the period needed for selling the house. To this end, a third party acts as intermediate financier. The function of intermediate finance in this case relates to either taking over the (first) right of the mortgagee on the property or by contract taking over the liability (i.e., obligation to pay) of payments on the mortgage from the seller, within a relatively short time after the seller has offered the property up for sale. At the later stage when a buyer presents oneself and the property is sold, the contractual arrangements of the third party and the seller are settled. As an advantage the mediation procedure releases the seller from his financial obligations within a period which is typically shorter than the period required for selling the property. This mediation procedure and settlement are described below in more detail. If in action 103 the affirmative option (yes) is selected, the intermediate information server continues the procedure in action 104.

In action 104, the intermediate information server IIS prompts for further information relating to the financial status concerning the property and the seller. For example, data relating to the fact if the house is mortgaged, to an identity of the mortgagee, and to an identity of the mortgagor may be requested. Also, data relating to a possible attachment (under applicable law) may be requested by the intermediate information server IIS.

Upon completion of any required input, the intermediate information server IIS prepares in action 105 mediation information which at a later stage may be put forward to a third party, who may decide to provide intermediate finance as explained above to the seller at a mediation price lower than the asking price.

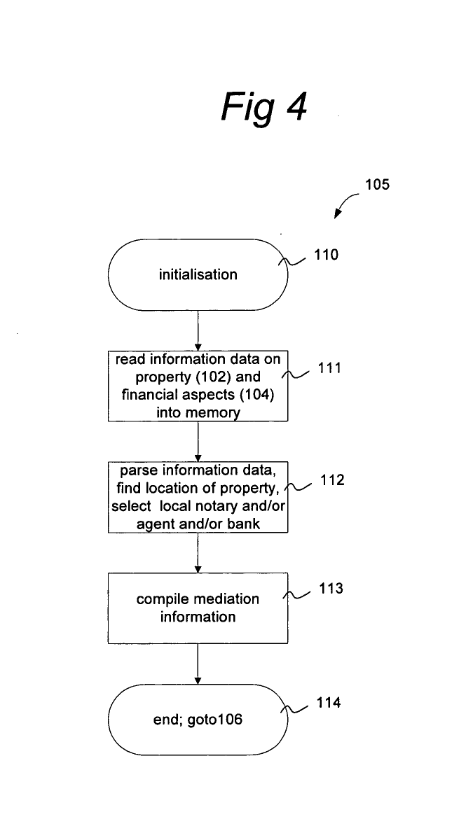

In action 105, the intermediate information server IIS compiles the mediation information data relating to the property such as the asking price and further data relevant to the financial status of the house and the seller such as discussed above in relation to action 104. This action 105 of the intermediate information server IIS is described in more detail below with reference to FIG. 4.

In action 106, the intermediate information server IIS stores the compiled set of mediation information data in the first database DB1 for storing and retrieving intermediate information.

After completion of action 106, the intermediate information server IIS continues procedure 100 in action 107 to store the intended sale of the property in the second database DB2 for storing and retrieving real estate information on the real estate server RS, which action has been described above. After action 107, the procedure ends in action 108.

Please note that the intermediate information server IIS may be capable of operation on a local, national or international scale. This implies that the IIS server may be capable to access to one or more real estate servers RS which provide real estate information to one or more different regions.

FIG. 4 depicts a second flow diagram of a method in accordance with an embodiment of the present invention.

In FIG. 4 a more detailed description of procedural action 105 is given.

After an initial action 110 which may comprise some initializing functions for the intermediate information server IIS, the intermediate information server IIS performs an action 111 to take the further information relating to the financial status concerning the property and the seller obtained in action 104 (i.e., read the related data into memory) and to take the data relating to the house obtained in action 102 (i.e., read the related data into memory).

In action 112, the intermediate information server IIS parses the data relating to the house and the further information relating to the financial status. From a third database DB3 which is accessible by the intermediate information server IIS and may be stored in memory of the intermediate information server IIS, the intermediate information server IIS retrieves business-related data in relation to the data and further information obtained earlier (in action 102 and action 104). The third database DB3 comprises contact information of at least one of notaries, real estate agents and banks.

From the third database DB3, the intermediate information server IIS retrieves based on the location of the property at least one of a contact address of a notary, a contact address of a real estate agent and a contact address of a bank located in the region of the location of the property.

Next, in action 113, the intermediate information server IIS compiles a set of mediation information data relating to the property (asking price, number of rooms, location etc.), the further information relating to the financial status and the contact information relating to at least one of a contact address of a notary, a contact address of a real estate agent and a contact address of a bank in the region of the location of the property. In relation to the possible regional, national or international operation of the intermediate information server IIS, where the property is located, the mediation information may comprise localized data that relate to specific provisions under the given law of the location of the property. To this end the server IIS may have access to a national law-related database DB4 (either in memory or located on the network) that provides any required legal information.

Further, the mediation information data may comprise data relating to a mediation price to paid by the third party as intermediate finance of the house (i.e., to obtain the (first) right of the mortgagee on the property or by contract take over the liability for payments on the mortgage from the seller).

Typically, the mediation price for the third party who acts as an intermediate financier will be somewhat lower than the asking price, say about 80% thereof. This price difference between mediation price and asking price creates a viable opportunity for the third party to invest and act as intermediate. It is assumed that at a later stage when the house is sold to the buyer, it will be against an actual selling price higher than the mediation price. At that time, the third party will obtain a sum of money equal to the mediation price plus a predetermined percentage of the actual selling price or a predetermined percentage of the mediation price. Also, costs and taxes paid during the intermediate finance actions carried out by the third party will be compensated here. As applicable, a certain commission will be paid to the real estate agent. Also, a commission is to be paid to the interim services provider. The remainder of the actual selling price will be paid to the original property owner (i.e., the seller).

The intermediate information server IIS may compile the set of mediation information data in a form which (later) is readable by a browser. Finally, the set of mediation information data is stored in the intermediate information first database DB1.

The procedural action 105 ends in action 1 14 and returns to action 106 of procedure 100.

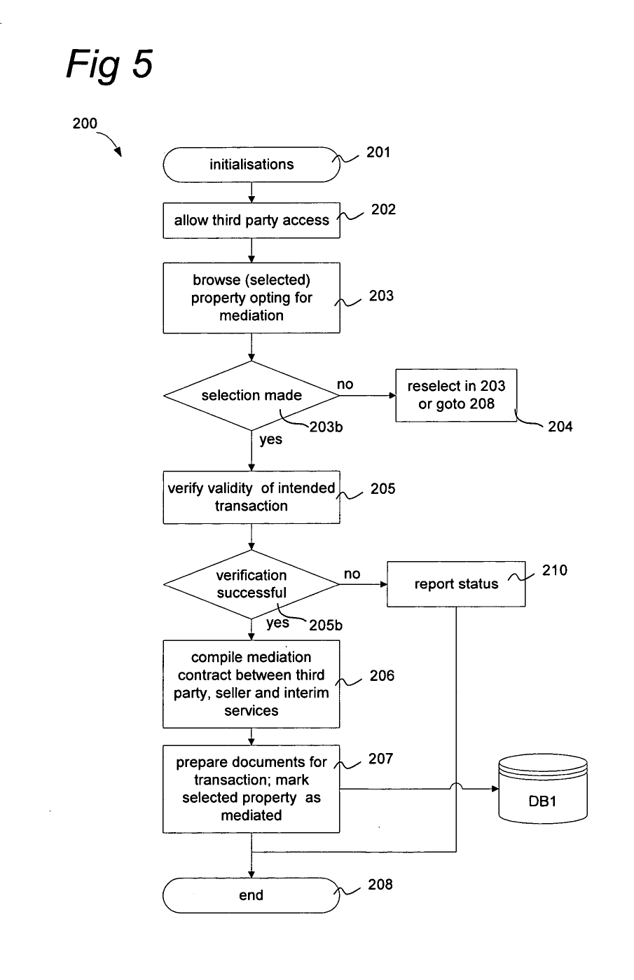

FIG. 5 depicts a third flow diagram of a method in accordance with an embodiment of the present invention.

The third flow diagram relates to the mediation procedure as facilitated by the interim services provider as described above.

The method according to the embodiment is carried out as shown in procedure 200.

Procedure 200 can be carried out by the intermediate information server IIS. An input device, for example, computer pc2 is used to communicate with the intermediate information server IIS. The input device is being used by the third party.

In action 201, the procedure begins. Possibly some initializations are performed by the intermediate information server IIS.

In action 202, the intermediate information server IIS allows data access over the network 33 to computer pc2 of the third party.

The third party is already known to the interim services provider. Any known login and authentication procedure as known in the art may be used here to identify the third party. It is noted that a direct access through a keyboard and display connected to the intermediate information server IIS may be applicable in stead of network-based access.

Next, in action 203, the intermediate information server IIS allows the third party to browse the intermediate information first database DB1 for mediation information data of property of which the respective seller has decided to opt for the interim services.

The browsing procedure can be done using any technology which provides ‘browser-enabled’ data over the network 33. For example, a web server program providing world-wide-web based data or hypertext based pages may be used in the intermediate information server IIS for this purpose. On computer pc2 a browser program is provided which is compatible with the protocol used by the server program.

In the browsing procedure some browsing criteria of the property as recorded in action 113, such as asking price, location, type of property, information on specific local regulations, can be made available.

The browsing procedure may allow some user-defined selection of property in the first database DB1 based on a choice of the browsing criteria.

In action 203b, if property is found which complies with the browsing criteria, the action 203 is ended, and the procedure 200 continues in action 205. If the browsing is not successful, the browsing may either be ended (in action 208) or be continued with other browsing parameters in action 204 (and return to action 203).

In action 205, the computer system carries out any required verifications relating to the selected property and the related mediation information to check whether a valid transaction can be made. For example, the verification may involve an examination of electronic records such as land register records, credit facility records, records of the register of mortgages. To this end, the intermediate information server IIS comprises in memory, possibly in a local or remote database (not shown), registration data on network addresses where to find these records. Again, depending on the regional, national or international operation of the server IIS, the registration data may relate to a set of one or more registers specific for the location of the property for sale.

Also, during the verification the data relating to the selected property as recorded in action 113 may be searched if needed or desired.

In action 205b, if the verification fails, the procedure 200 is continued in action 210.

In action 206, when an affirmative selection of property is made, a mediation contract is compiled based on the mediation information data established beforehand. The purpose of the mediation contract is to provide a legal document for the mediation. The mediation contract may comprise any type of transaction as required to the third party and to provide to the seller (previous owner) a first payment of a mediation price as preliminary amount for the selected property.

In action 210, the intermediate information server IIS prepares a report on the status to explain the failure. Then, the procedure ends in action 208.

In action 207, if the opportunity to carry out a transaction has verified to be successful, the intermediate information server IIS prepares documents relating to the legal transaction between seller and third party, i.e. the legal transfer of the right of the mortgagee on the property and/or any right in rem (i.e., for example a contract to take over the liability of payments on the mortgage) relating to the property. The preparation may involve application of specific national provisions relating to the transaction.

If required by the third party, from the mediation contract data recorded for the property in action 113, data relating to a real estate agent, a notary and a bank in the area of the property may be used in the preparation of the transaction and the legal documents needed in the transaction. Also, through recorded electronic addresses of these institutions, electronic messages may be used to communicate the transactions to one or more of them.

Finally, in action 207, the records relating to the property for sale in the intermediate information first database DB 1 are marked to indicate that a third party has indicated to temporarily take over the right of the mortgagee on the property and/or the liability of payments on the mortgage. In action 208, the procedure 200 ends.

Upon completion of procedure 200, the transaction between the seller and the third party can be made before the notary (as selected above in action 207). In agreement with the mediation contract, the notary can also take care of compiling a mortgage deed. Also, he can take care of making a first payment of the mediation price to the seller of the property. Also, the notary can take the necessary actions to have the transaction (and any rights for consideration) recorded in any related register as required.

Furthermore, when at a later stage, the property is sold to a buyer (a final new owner), the notary can finalize the agreement between the third party, the seller, and the interim services provider. Based on the agreement, i.e., the mediation contract between parties (the seller, the interim service provider and the third party), the notary can see to the final settlement. The third party will obtain a sum of money equal to the mediation price plus a predetermined percentage of the actual selling price or a predetermined percentage of the mediation price. Also, his expenses (costs) for providing the intermediate finance will be compensated. Further, in accordance with the mediation contract a commission is to be paid to the interim services provider. As may be applicable and may be stated in the mediation contract, a certain commission will be paid to the real estate agent. The remainder of the actual selling price will be paid to the original seller.

When the final sale to the buyer has occurred, the intermediate information server IIS carries out an update of the intermediate information database DB1 for removal of the involved property as an object for sale. Also, the intermediate information server IIS may transmit some indication (for example, an electronic message or a program instruction) to the (respective) real estate server RS that holds sales information on the involved property that the given property is no longer for sale.

It is noted that in some embodiments the intermediate information server computer system IIS may be hosted within the same computer device as the real estate information server computer system RS. In these and/or other embodiments, the intermediate information server computer system IIS may comprise the real estate information server computer system RS as a subsystem. Skilled persons will appreciate how to provide communication signals (e.g., property sold) between the intermediate information server IIS and the real estate information server computer system RS under these circumstances.

1-20. (canceled)

21. A method for facilitating a real estate transaction of a property for sale from a seller, the method comprising:
establishing sales information on at least an asking price for the property;
establishing further information on the financial status of the property and seller;
preparing mediation information for a third party for an intermediate finance of the property for a mediation price; and
determining the mediation price in dependence on the asking price, wherein the mediation price is lower than the asking price.

22. The method according to claim 21, wherein the preparation of mediation information comprises:
establishing a notary, a real estate agent, a bank or any combination thereof, having a location in the area of the location of the property for sale; and
retrieving a contact address for the established notary, real estate agent and/or bank.

23. The method according to claim 21, wherein the method comprises:
allowing a third party access to the mediation information for selection;
upon selection by the third party for providing intermediate finance for the property, preparing a mediation contract based on the mediation information, wherein the mediation contract comprises information on the intended transaction between the seller and the third party.

24. The method according to claim 21, wherein the method comprises:
verifying a validity of the intended transaction between the seller and the third party by an examination of records of a land register, a credit facility, register of mortgages, or any combination thereof.

25. The method according to claim 21, wherein the method comprises:
preparing documents for assistance in the legal transaction between the seller and the third party in relation to the intermediate finance of the property.

26. The method according to claim 21, wherein the method comprises carrying out a first payment of the mediation price to the seller and providing instructions for said carrying out of the first payment of the mediation price to the seller.

27. The method according to claim 21, wherein the method comprises carrying out a settlement between the seller and the third party after a sale of the property to a buyer.

28. A system to facilitate a real estate transaction of a property for sale from a seller, the system comprising a first database comprising:
sales information on at least an asking price for the property;
further information on the financial status of the property and seller;
mediation information for a third party for an intermediate finance of the property for a mediation price, wherein the mediation price is determined in dependence on the asking price, and wherein the mediation price is lower than the asking price.

29. The system according to claim 28, wherein the mediation information comprises:
a contact address of a notary, a real estate agent, a bank or any combination thereof, having a location in the area of the location of the property for sale.

30. The system according to claim 28, wherein the first database includes, upon selection by the third party for providing intermediate finance for the property, a mediation contract based on the mediation information, and wherein the mediation contract comprises information on the intended transaction between the seller and the third party.

31. The system according to claim 28, wherein the system comprises:
verification information on a validity of the intended transaction between the seller and the third party by an examination of records of a land register, a credit facility, register of mortgages, or any combination thereof.

32. The system according to claim 28, wherein the system comprises documents prepared for assistance in the legal transaction between the seller and the third party in relation to the intermediate finance of the property.

33. The system according to claim 28, wherein the system is capable of providing instructions for carrying out a first payment of the mediation price to the seller.

34. The system according to claim 28, wherein the system comprises a settlement between the seller and the third party after a sale of the property to a buyer.

35. An intermediate information server to facilitate a real estate transaction of a property for sale from a seller, comprising a processing unit, memory and a network I/O device for a connection to a network, the memory being connected to the processing unit, and the network I/0 device being connected to the processing unit, wherein the intermediate information server is configured to:
establish sales information on at least an asking price for the property;
establish further information on the financial status of the property and seller;
prepare mediation information for a third party for an intermediate finance of the property for a mediation price; and
determine the mediation price in dependence on the asking price, wherein the mediation price is lower than the asking price.

36. A computer system to facilitate a real estate transaction of a property for sale from a seller, and comprising a processing unit and memory, the memory being connected to the processing unit, the computer system being configured to:
establish sales information on at least an asking price for the property;
establish further information on the financial status of the property and seller;
prepare mediation information for a third party for an intermediate finance of the property for a mediation price; and
determine the mediation price in dependence on the asking price, wherein the mediation price is lower than the asking price.

37. The computer system according to claim 36, wherein the computer system further hosts or includes a real estate information server (RS).

38. A computer program to facilitate a real estate transaction of a property for sale from a seller, to be loaded by a computer system, the computer system comprising a processing unit and memory, the processing unit being connected to the memory, the computer program product after being loaded allows the processing unit to: establish sales information on at least an asking price for the property;
establish further information on the financial status of the property and seller;
prepare mediation information for a third party for an intermediate finance of the property for a mediation price; and
determine the mediation price in dependence on the asking price, wherein the mediation price is lower than the asking price.

39. A computer program to facilitate a real estate transaction of a property for sale from a seller, to be loaded by an intermediate information server, the intermediate information server comprising a processing unit, memory and a network I/O device for a connection to a network, the memory being connected to the processing unit, and the network I/O device being connected to the processing unit, the computer program product after being laded allows the processing unit to:
establish sales information on at least an asking price for the property;
establish further information on the financial status of the property and seller;
prepare mediation information for a third party for an intermediate finance ofthe property for a mediation price; and
determine the mediation price in dependence on the asking price, wherein the mediation price is lower than the asking price.

40. A data carrier for a computer program in accordance with claim 38.

41. A data carrier for a computer program in accordance with claim 39.
